(19) United States
(12) Patent Application Publication
(10) Pub. No.: US 2013/0143776 A1
(43) Pub. Date: Jun. 6, 2013

(54) USE OF WAX-COATED SAND GRAINS FOR ELIMINATION OF OIL CONTAMINATION OR FOR SEALING OF WELLS

(71) Applicant: Norbert Beermann, Munchen (DE)

(72) Inventor: Norbert Beermann, Munchen (DE)

(21) Appl. No.: 13/697,617

(22) PCT Filed: May 27, 2010
(86) PCT No.: PCT/EP2010/003227

§ 371 Date: Feb. 20, 2013

(30) Foreign Application Priority Data
May 14, 2010 (DE) 10 2010 020 455.2

(51) Int. Cl. C09K 3/32

(52) U.S. Cl. CPC C09K 3/32
USPC 507/203; 510/365; 210/680

(57) ABSTRACT

The present invention provides for the use of discrete or agglomerated sand grains provided completely or partially with a coating consisting of wax as an oil binder for elimination of oil contamination.

The inventive use serves especially for elimination of oil contamination in the form of oil films or oil carpets on water surfaces, or of oil contamination in the form of oil films on solid traffic surfaces, or as an oil binder for sealing of wells in the event of mineral oil production accidents.

### FIELD OF THE INVENTION

The invention relates to the use of wax-coated sand grains as oil binders for elimination of oil contamination in the form of oil films or oil carpets on water surfaces or in the form of oil films on solid traffic surfaces, and as an oil binder for sealing of wells in the event of mineral oil production accidents.

### STATE OF THE ART

Oil binders are used in the abatement of oil damage for binding or absorption of oils on open water or on solid traffic surfaces. Oil binders are usually fine-grained or pulverulent, in some cases also liquid. In addition, there are also floatable oil binders which are often used in combination with floating oil barriers for elimination of mineral oils on water. The base materials of the oil binders are mineral or else vegetable substances, especially maize stalk pellets.

The conventional oil binders are generally disadvantageous in that the production thereof is inconvenient and costly, and often entails the addition of toxic and environmentally polluting substances. Moreover, the storage and transport of the oil binders containing oil contamination, after they have been used, entails special measures, just like the disposal of the oil binder mixed with oil, which is stipulated by waste legislation.

As is evident from the current media coverage (May 2010) regarding the oil spill in the Gulf of Mexico, attempts are also made in the case of oil accidents in deep-sea wells to control the crude oil emerging from the leaks directly with environmentally polluting chemicals.

DE 196 15 896 C2 discloses a rigid sand body consisting of a multitude of sand grains provided with a coating consisting of wax which adhere to one another. Abrasion of the sand body gives discrete or agglomerated sand grains provided with a coating consisting of wax. The wax-coated sand grains are said to be suitable as lubrication and sliding bases, as a filling material or as a cushioning material in long-jump pits.

### OBJECT OF THE INVENTION

It is an object of the invention to provide an oil binder which does not include any toxic or environmentally polluting substances and can be provided by a simple and inexpensive process. The oil binder should be suitable for elimination of oil contamination on water surfaces and on solid traffic surfaces, and likewise for sealing of wells in the event of mineral oil production accidents.

### SUMMARY OF THE INVENTION

The object underlying the invention is achieved by the use of discrete or agglomerated wax-coated sand grains according to claim 1. Advantageous and particularly appropriate embodiments of the subject-matter of the application are specified in the dependent claims.

The invention thus provides for the use of discrete or agglomerated sand grains provided completely or partially with a coating consisting of wax as an oil binder for elimination of oil contamination.

The inventive use thus envisages a novel process for cleaning oil-polluted water surfaces or oil-polluted solid traffic surfaces in an advantageous manner to free them of the oil by use of environmentally compatible materials, namely natural sand coated with an environmentally friendly additive, namely wax. Moreover, the oil binder described in accordance with the invention is suitable for sealing of wells in the event of mineral oil production accidents, both on land and under water.

### DETAILED DESCRIPTION OF THE INVENTION

According to the invention, it has been found that, surprisingly, a product consisting solely of sand grains and wax, the wax completely or partially coating the sand grains, can be used in various ways as an oil binder for elimination of oil contamination.

The weight ratio of sand to wax here may suitably be about 8:1 to 50:1, preferably 20:1 to 30:1.

The sand usable in the inventive use is not subject to any particular restriction. The sand grains typically have a diameter of 0.06-3 mm and, according to particle size, are referred to as fine sand (equivalent diameter of typically 0.06-0.2 mm), medium sand (equivalent diameter of typically 0.2-0.63 mm) or coarse sand (equivalent diameter of typically 0.63-3.0 mm). Preference is given to using sand having a diameter of 0.1-0.5 mm. For example, it is possible to use dune sand from beaches wherein the grains typically have a diameter of about 1 mm or less, and which may optionally be ground to the desired particle size.

The wax used in the invention is not subject to any particular restriction either; wax is normally kneadable at room temperature, melts without decomposition above 40° C., is of comparatively low viscosity above the melting temperature range and does not form threads. In general, waxes are converted, for instance, to the molten, low-viscosity state between 50 and 90° C. For the inventive purposes, natural, chemically modified or synthetic waxes, or combinations thereof, are suitable.

Examples of natural waxes are vegetable waxes, such as candelilla wax, carnauba wax, japan wax, esparto grass wax, cork wax, guaruma wax, rice germ oil wax, sugarcane wax, ouricury wax and montan wax, animal waxes such as beeswax, shellac wax, spermaceti and lanolin, mineral waxes such as ceresin and ozokerite or petroleum wax, petrochemical waxes such as petrolatum, paraffin waxes and micro waxes.

Examples of chemically modified waxes are hard waxes such as montan ester waxes, sasol waxes and hydrogenated jojoba waxes.

Examples of synthetic waxes are polyalkylene waxes and polyethylene glycol waxes.

Discrete sand grains provided completely or partially with a coating consisting of wax are understood herein to mean individual sand grains provided completely or partially with a coating consisting of wax.

Agglomerated sand grains provided completely or partially with a coating consisting of wax are understood to mean assemblies of a plurality of sand grains, each individual sand grain having a complete or partial wax coating and the outer agglomerate surface having a complete or partial wax coating. Such agglomerates may have equivalent diameters of up to several centimetres, for instance to 5 cm. Such agglomerates can also be obtained, for example, by dividing the rigid sand bodies described in DE 196 15 896 C2.

A particularly preferred use of the above-described oil binder relates to the elimination of oil contamination in the form of oil films or oil carpets on water surfaces, wherein the oil binder is applied to the oil films or oil carpets in order to bind the oil contamination, and the mass composed of oil binder and the bound oil contamination formed, after falling to the water bed, is retrieved therefrom and disposed of.

In the case of this use, it has been found that the oil binder very rapidly binds the oil contamination and the mass composed of oil binder and the bound oil contamination formed sinks immediately after the absorption of the oil and collects on the water bed in the form of carpets or lumps. The oil is bound stably within this mass and can be separated and collected from the sea bed or water bed by means of suitable equipment or machinery, provided that the abatement of oil damage is not taking place in excessively deep water and preferably close to the bank. Since the mass composed of oil binder and bound oil contamination formed holds the oil in a stable manner, this mass can be stored and then transported away without any great problems and without polluting the environment close to the bank. The fact that the mass composed of oil binder and the bound oil contamination formed settles out in water is considered to be particularly surprising since not only do oil and wax float on the water, but the above-described oil binder composed of wax-coated sand grains is also floatable.

For the abatement of oil damage by oil contamination on water surfaces, in accordance with the invention, a suitable volume ratio of oil contamination to oil binder is from about 1:1 to about 1:6, especially about 1:2 to about 1:4.

A further preferred use of the above-described oil binder relates to the elimination of oil contamination in the form of oil films on solid traffic surfaces, wherein the oil binder is applied to the oil films in order to bind the oil contamination and the mass composed of oil binder and the bound oil contamination formed is retrieved and disposed of

In this application, a weight ratio of oil contamination to oil binder is selected such that the mass composed of oil binder and the bound oil contamination formed is sweepable and can be swept up by hand or by means of a roadsweeper. On public roads and traffic surfaces, it is generally necessary, after the retrieval of the contaminated oil binder, also to conduct a wet cleaning operation.

One advantage of the uses described in accordance with the invention is that the mass composed of oil binder and the bound oil contamination formed can be disposed of by supplying it to power generation by incineration in incineration furnaces. For example, the retrieved mass composed of oil-contaminated oil binder can be incinerated in power plants. The sole waste product which remains after such an incineration is the sand starting material, but now back in its pure, natural sand grain form without wax coating and without oil contamination.

This sand, just like naturally occurring sand, can be used again for production of discrete or agglomerated sand grains provided completely or partially with a coating consisting of wax. For production of the wax-coated sand grains to be used as oil binders in accordance with the invention, the sand grains and the starting wax are preferably heated separately to a temperature of 50-90° C., preferably 60-90° C., the heated sand grains and the heated liquid wax are combined, and the mixture is left to cool with constant mixing or motion in suitable mixing apparatus. According to the mixing ratio of wax to sand grains, this affords discrete or agglomerated sand grains coated completely or partially with wax, which are free-flowing, and can be packed in suitable containers and used in accordance with the invention as oil binders for elimination of oil contamination.

The production of the oil binder used in accordance with the invention is particularly advantageous from ecological aspects and from the aspect of cost saving, since the wax coating, according to geographical location, can be performed solely by means of solar energy.

This closes an environmentally compatible circle, starting with the wax-coated sand produced by means of solar energy (or else of course by means of other energies), the abatement of oil spills by means of the prepared sand, and finally the disposal of the waste mass by incineration with energy generation, ultimately resulting again in pure sand, without pollution of water and bank regions by escaped oil as usual in the case of oil spills, and without generally great economic damage through the loss of the massive amounts of oil, since oil can be collected in the sand for further incineration.

From cost aspects too, the use proposed in accordance with the invention for elimination of oil contamination on water surfaces and on solid traffic surfaces is advantageous, since both the sand and wax starting materials and the production of the oil binder used in accordance with the invention are inexpensive. The inventive use does not poison water and bank regions with chemical substances, as is the case for many existing methods for dissolution of oil carpets on water surfaces. In order to be able to perform the oil damage abatement close to the bank, however, it may be necessary to provide floating oil protection barriers or barriers on the water surface in the bank region, in order to prevent the penetration of oil contamination onto land. On the other hand, however, the application of the oil binder to the oil carpets or oil films can be performed more easily close to the bank, and the mass composed of oil binder and the bound oil contamination formed can be retrieved more easily from the water bed and then disposed of.

A further inventive use of the above-described oil binder relates to the sealing of wells in the event of mineral oil production accidents, both on land and underwater, wherein the oil binder is introduced into the oil exit wells in a sufficient amount to seal or to block the exit wells by means of the mass composed of oil binder and bound oil which forms in situ. In the case of this use, it is also possible first to introduce relatively large agglomerates of wax-coated sand grains having diameters of up to several centimetres under pressure into the oil exit wells, in order to achieve more effective and rapid blockage. The sealing or blockage is then subsequently completed by means of the mass composed of oil binder and bound oil which forms in situ.

### EXAMPLES

The invention is illustrated in detail by the working examples which follow.

### Example 1

A bowl of diameter 20-30 cm filled with approx. 2-3 litres of water is “contaminated” with 3 tablespoons of vegetable cooking oil. It is observed that an oil film forms on the water surface and this floats on the water surface.

Then wax-coated sand grains are scattered thereon. A thin sand layer forms on the water and on the oil. After some agitation of the water vessel in order thus to imitate water waves, the sand falls to the base of the bowl and entrains the oil with it. In the course of further agitation of the bowl, the surface of the water is oil-free again after a short time. The oil forms lumps at the base with the sand; it is actually absorbed by the sand. The water, which is now oil-free at the surface after the prepared sand has sunk, is then poured into a small bucket. As it is poured out, it is found that the water flows out rapidly and collects in the bucket, while the sand with the oil remains in the bowl, now without water.

Result: The water in the bucket has become so clean that it can be used for hand-washing without leaving oil residues on the hands.

### Example 2

Example 1 is repeated, except using about ⅛ litre of diesel oil rather than vegetable cooking oil.

With this amount of diesel oil, a thick diesel oil carpet now forms on the water surface, which covers the entire bowl. Now the prepared sand grains are again scattered onto the oil carpet. On the water surface, a substantial sand carpet then forms, which gradually sinks downward even without any agitation and pulls the diesel oil downward with it. Thereafter, the sand carpet lies at the base of the water vessel, partly permeated with sand lumps, fully saturated with the diesel oil. After a certain time, the water surface, particularly after shaking of the bowl, has been completely freed of the oil. The water is poured off again and introduced into a bucket.

Result: This water too can again be used for hand-washing without leaving diesel oil residues on the hand.

### Example 3

Example 1 is repeated, except that this time, in order to imitate seawater, cooking salt is poured into the water.

Then ⅛ litre of vegetable cooking oil are again added, such that a thick oil layer floats on the water. The prepared, wax-coated sand is poured onto it. Surprisingly, the sand now slides very rapidly into the depths and entrains the oil layers with it. After a very short time, i.e. much more quickly than in the case of the normal, salt-free water, the sand pulls the oil carpet downward. It is found, however, that some oil spots (probably due to the process of rapid sinking of the prepared sand) are visible on the water surface. Therefore, additional wax-coated sand is scattered onto the remaining oil spots. The sand now remains on the water surface like icing sugar and no longer sinks immediately (in the case of pure, oil-free water, the prepared, wax-coated sand generally remains like icing sugar on the water surface). Only after vigorous wave movements, caused by shaking of the bowl, does this sand too sink to the base of the bowl. The water surface is now totally clean. This water was collected in a 2 litre bottle; even after several days, no oil film or oil spots have occurred on the water surface in the bottle. The water in the bottle is virtually oil-free and clean.

### Example 4

Example 1 is repeated, except that this time heavy, slightly viscous oil (motor oil) is poured onto the water surface. It forms a very thick layer of heavy oil on the water surface. Then the prepared, wax-coated sand is applied thereto. This sand does not slip immediately through the water surface, but remains on the thick oil layer. In the case of further addition of prepared sand, a thick sand layer then forms on the oil carpet. Suddenly, this sand carpet collapses at one point, it sinks slightly, the clean water runs over this sunken area and extends over the entire coherent sand carpet and forces the sand carpet downward. Over large areas, the oil layer is now pulled to the base together with the sand carpet. Thereafter, a second scattering of sand onto the water surface is undertaken. Now only a very thin sand layer like icing sugar remains on the water. After some agitation of the bowl, this thin sand layer too slides downward and takes the last oil spots with it.

Result: The water is decanted again and introduced into a bottle; this water too is clean.

### Comparative Example 1 and Example 5

Example 1 is repeated, but with normal, natural sand, and in parallel with prepared, wax-coated sand. In each bowl is approx. 1 litre of water. Approx. ⅛ litre of diesel oil is added to both bowls. Due to the small amount of water, this diesel oil at first falls to the base of the water vessel and then swells upward to the water surface and spreads out as a thick oil layer on the water surface.

In bowl 1 (comparative example 1), normal, natural sand is then scattered; in bowl 2 (example 5), the prepared, wax-coated sand is scattered (diameter of the sand grains between 0.1 and 0.5 mm).

Result:

In bowl 1, the natural sand falls very rapidly to the base of the vessel and is distributed over the entire area of the base. The water surface remains very cloudy; the diesel oil floats above it as a thick film, now partly mixed with sand.

In bowl 2, the prepared, wax-coated sand likewise sinks quite rapidly to the base and entrains the oil downward with it. At the base, the sand forms lumps, but the water surface loses its oily film, and the water appears clear.

### Example 6

A transparent, empty 1 litre bottle is used, into which ⅛ litre of diesel oil is introduced. Then the wax-coated sand grains are introduced through the bottle opening. The wax-coated sand grains penetrate into the diesel oil layer and become fully saturated. It is found that, in the case of introduction of too small an amount of wax-coated sand grains, a reduced diesel oil layer still forms above the sand. In the case of further supply of wax-coated sand grains, the rest of the diesel oil layer is also fully absorbed. A solid slurry composed of wax-coated sand grains, fully saturated with diesel oil, is formed in the bottle. Even when the bottle is inverted, even though the bottle is only about half-full with the mixture of wax-coated sand grains and diesel oil, this solid slurry remains suspended at the base of the bottle. No diesel oil drips out of it and only gradually does this slurry break into small lumps downward, but diesel oil still does not escape.

1. Use of discrete or agglomerated sand grains provided completely or partially with a coating consisting of wax as an oil binder for elimination of oil contamination.

2. Use according to claim 1, wherein the wax-coated sand grains have a weight ratio of sand to wax of 8:1 to 50:1, preferably 20:1 to 30:1.

3. Use according to claim 1, wherein the sand grains have a diameter of 0.06-3 mm, preferably 0.1-0.5 mm.

4. Use according to claim 1, wherein the wax is a natural, chemically modified or synthetic wax or combinations thereof.

5. Use according to claim 1 for elimination of oil contamination in the form of oil films or oil carpets on water surfaces, wherein the oil binder is applied to the oil films or oil carpets in order to bind the oil contamination, and the mass composed of oil binder and the bound oil contamination formed, after falling to the water bed, is retrieved therefrom and disposed of.

6. Use according to claim 1 for elimination of oil contamination in the form of oil films on solid traffic surfaces, wherein the oil binder is applied to the oil films in order to bind the oil contamination and the mass composed of oil binder and the bound oil contamination formed is retrieved and disposed of.

7. Use according to claim 5, wherein the mass composed of oil binder and the bound oil contamination is disposed of by supplying it to power generation by incineration in incineration furnaces.

8. Use of discrete or agglomerated sand grains provided completely or partially with a coating consisting of wax as an oil binder for sealing of wells in the event of mineral oil production accidents, wherein the oil binder is introduced into the oil exit wells in a sufficient amount to seal or to block the exit wells by means of the mass composed of oil binder and bound oil which forms in situ.
